(19) United States
(12) Patent Application Publication
(10) Pub. No.: US 2011/0316816 A1
(43) Pub. Date: Dec. 29, 2011

(54) Drive circuit of display device and its driving method

(75) Inventors: Shinichi Okuma, Kanagawa (JP); Nobuyuki Yuki, Kanagawa (JP)

(73) Assignee: Renesas Electronics Corporation, Kanagawa (JP)

(21) Appl. No.: 13/067,674

(22) Filed: Jun. 20, 2011

(30) Foreign Application Priority Data
Jun. 29, 2010 (JP) 2010-147150

(51) Int. Cl. G09G 5/00

(52) U.S. Cl. 345/204

(57) ABSTRACT

A drive circuit 100 includes an internal counter 301 within its data driver N. The internal counter 301 is reset when a first data driver 1 reads the first signal of display data. A cascade signal (CASCADE) is input from a previous stage of the data driver N−1. When the counter value becomes equal to a first set value, the internal counter 301 is reset and the current stage of the data driver starts to read display data. When the counter value becomes equal to a second set value calculated by Expression (1), a counter unit 300 supplies a cascade signal to a subsequent stage of the data driver N+1.

### CROSS-REFERENCE TO RELATED APPLICATIONS

This application is based upon and claims the benefit of priority from Japanese patent application No. 2010-147150, filed on Jun. 29, 2010, the disclosure of which is incorporated herein in its entirety by reference.

### BACKGROUND

The present invention relates to a drive circuit of a display device and its driving method.

In recent years, as the screen size of liquid crystal display panels has become larger, the number of pixels on one source line has been increasing. As a result, it is desired to develop a driver having a larger number of pins. Further, since the display time in one horizontal period has become shorter because of high-speed driving operations such as double-speed driving and quadruple-speed driving, it is desired to make the operation of such drivers faster.

Japanese Unexamined Patent Application Publication No. 2008-070641 (Fukuo) discloses a drive circuit of a liquid crystal panel. This drive circuit includes a controller and a data driver. Further, the data driver includes a shift register, a data register, a data latch circuit, and a driver circuit.

Further, the shift register receives a start signal and outputs shift pulses in succession to the data register in synchronization with a clock signal. Further, the shift register outputs a start signal to the next data driver.

### SUMMARY

However, the present inventors have found the following problem. As shown in FIG. 16, in the drive circuit disclosed in Fukuo, the cascade latch margin is dependent on the frequency-division clock (CLK_I). When the frequency of the frequency-division clock is low, the delay time (tCAS) of the cascade signal is smaller than the cascade latch margin. Therefore, the data driver can latch the cascade signal at a proper timing determined by that frequency-division clock. Note that the cascade single is a timing signal that specifies the timing when the data driver takes in data.

However, when the frequency of the frequency-division clock is high, the delay time (tCAS) of the cascade signal becomes larger than the cascade latch margin. Therefore, the data driver latches the cascade signal at a timing that is one cycle later than the original (proper) timing. As a result, the data driver recognizes a wrong data read start point, and thereby causing a problem that the data continuity between data drivers is disrupted.

For example, assume a case where the delay time (tCAS) of the cascade signal is 15 to 20 ns and the date driver latches the cascade signal by one-fourth frequency. In this case, the frequency of the original frequency-division clock can be increased only to around 200 MHz at the maximum. Note that the maximum frequency (fCLK) of the frequency-division clock is obtained by the following expression.

$$\begin{matrix}fCLK = 1 / ( tCAS / ( number by which the frequency is divided ) ) \\ = 1 / ( 20 ns / 4 ) \\ = 200 MHz\end{matrix}$$

A first aspect of the present invention is a drive circuit of a display device including a plurality of data drivers connected in series. The plurality of the data drivers successively read display data to be output to the display device. Further, each of the data drivers includes a counter unit. Further, the counter unit includes an internal counter that counts based on an internal clock. Further, a common timing signal is input to each of the data drivers at a timing when a first stage of the data driver reads a first signal of the display data, and each of the internal counter is thereby reset. Next, when a cascade signal specifying a timing when reading of the display data is performed is input from a previous stage of the data driver to the current stage of the data driver and a counter value of the internal counter becomes equal to a first set value which is the number of outputs of the previous stage of the data driver, the internal counter is reset and readout of the display date in the current data driver starts. Next, when the counter value becomes equal to a second set value, the counter unit of the current data driver supplies the cascade signal to a subsequent stage of the data driver. Then, when a delay clock number of the cascade signal is defined as a value obtained by dividing a delay time of the cascade signal by a system clock and rounding off the resultant value to a nearest whole number, the second set value is calculated by Expression (1) shown below.

(second set value)=(number of outputs of current stage of data driver)−(delay clock number) (1)

In a first aspect of the present invention, a common timing signal is input at a timing when the readout of display data starts in the first stage of the data driver, and the internal counters are thereby reset. Therefore, the count operation by the internal counter in the current stage of the data driver is performed simultaneously with the readout operation of the display data and the count operation by the internal counter performed in the previous stage of the data driver.

Next, when a cascade signal (CASCADE) is input from a previous stage of the data driver N−1 and the counter value of the internal counter in the current stage of the data driver becomes equal to the first set value, that internal counter is reset and the readout of the display data in the current stage of the data driver starts. In this way, it is possible to start the readout of the display data in the current stage of the data driver at a timing when the readout of the display data in the previous stage of the data driver has finished. Further, the count operation by the internal counter in the current stage of the data driver starts from the moment when the reading of display data in the current stage of the data driver starts.

Next, when the counter value of the internal counter of the current stage of the data driver becomes equal to the second set value, the counter unit supplies the cascade signal to the subsequent stage of the data driver. Since the delay clock number of the cascade signal is taken into account in the second set value, the counter unit can supply the cascade signal to the subsequent stage of the data driver at a timing that is in advance by an amount equivalent to the delay clock number of the cascade signal.

In other words, the counter unit can supply the cascade signal to the subsequent stage of the data driver in advance by an amount equivalent to the delay time of the cascade signal. In this way, the subsequent stage of the data driver can start to read the display data at the original (proper) timing regardless of the relation between the delay time of the cascade signal and the clock cycle of the system clock. Therefore, it is possible to maintain the continuity of the display data between data drivers.

According to the present invention, it is possible to provide a drive circuit of a display device and its driving method capable of maintaining the data continuity between data drivers regardless of the relation between the delay time of the cascade signal and the clock cycle of the system clock.

### BRIEF DESCRIPTION OF THE DRAWINGS

The above and other aspects, advantages and features will be more apparent from the following description of certain embodiments taken in conjunction with the accompanying drawings, in which:

FIG. 1 is a block diagram showing an example of a configuration of a drive circuit according to a first embodiment of the present invention;

FIG. 2 is a block diagram showing an example of a configuration of a data driver according to a first embodiment of the present invention;

FIG. 3 is a timing chart for explaining input/output timings of a cascade signal and the counter value of an internal counter in a drive circuit according to a first embodiment of the present invention;

FIG. 4 is a timing chart for explaining input/output timings of a cascade signal and the counter value of an internal counter in a drive circuit according to a first embodiment of the present invention;

FIG. 5 is a timing chart showing a relation between data read timings in a data driver N and a data driver N+1 and the counter value of an internal counter according to a first embodiment of the present invention;

FIG. 6 is a block diagram showing an example of a configuration of a data driver according to a second embodiment of the present invention;

FIG. 7 is a timing chart showing input/output timings of a cascade signal (CASCADE) in each data driver of a drive circuit according to a second embodiment of the present invention;

FIG. 8 is a timing chart showing an operation of an internal counter according to a second embodiment of the present invention;

FIG. 9 is a block diagram showing an example of a configuration of a driver output number recognition circuit according to a second embodiment of the present invention;

FIG. 10 is a block diagram showing an example of a configuration of a decoder according to a second embodiment of the present invention;

FIG. 11 is a table showing an example of a relation among the number of outputs, a carry signal, and the number of pulses indicating that number of outputs according to a second embodiment of the present invention;

FIG. 12 is a timing chart showing an operation in a driver output number recognition circuit of a data driver N according to a second embodiment of the present invention;

FIG. 13 is a timing chart that follows the timing chart shown in FIG. 12;

FIG. 14 is a timing chart showing an operation in a certain data driver N connected in a cascade configuration according to a second embodiment of the present invention;

FIG. 15 is a timing chart that follows the timing chart shown in FIG. 14; and

FIG. 16 is a timing chart showing an operation of a drive circuit in related art.

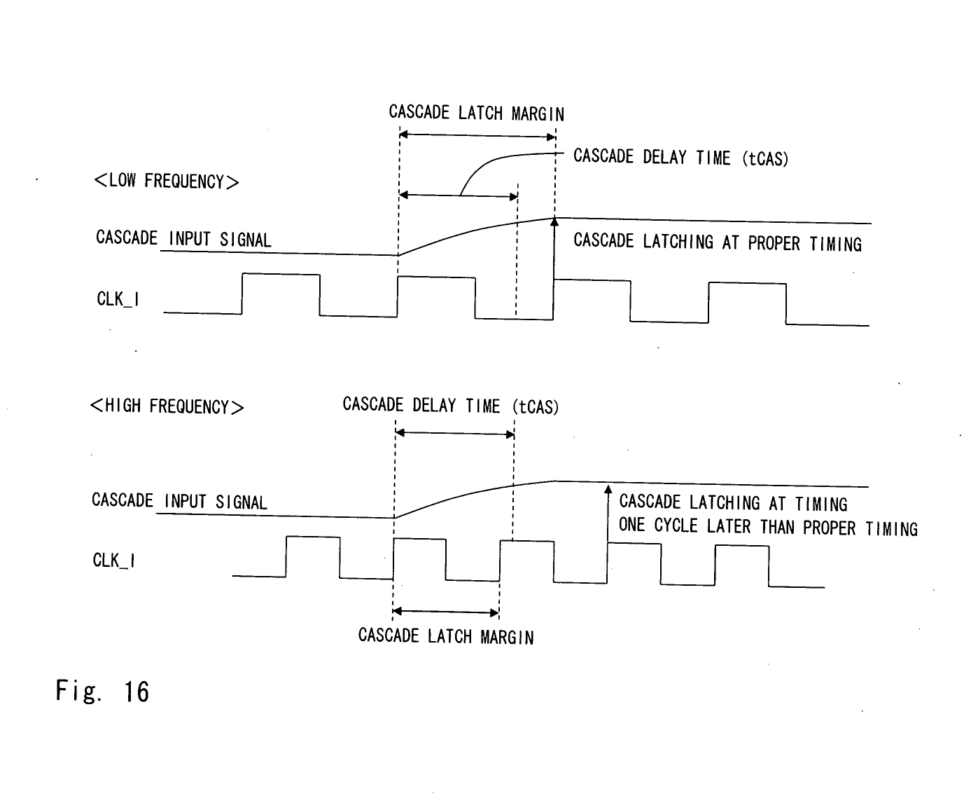

### DETAILED DESCRIPTION

Embodiments to which the present invention is applicable are explained hereinafter. Note that the present invention is not limited to the following embodiments.

### First Embodiment

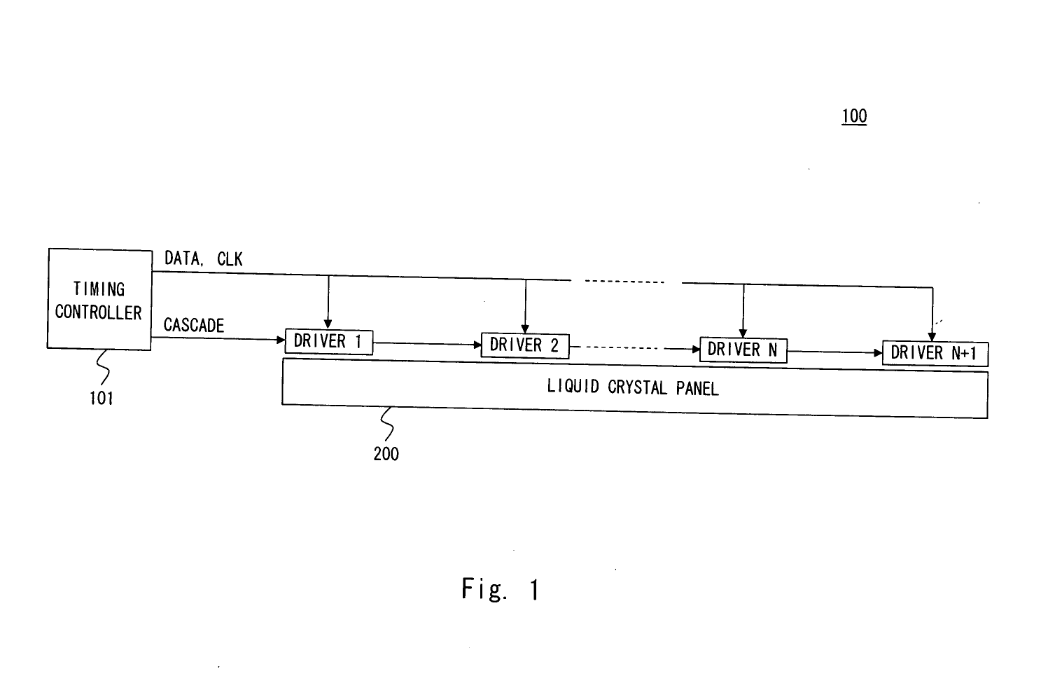

FIG. 1 is a block diagram showing an example of a configuration of a drive circuit 100 according to a first embodiment of the present invention. The drive circuit 100 is a drive circuit of a liquid crystal panel 200.

As shown in FIG. 1, the drive circuit 100 includes data drivers 1, 2, . . . , N, and N+1 (N is a positive integer) and a timing controller 101.

The data drivers 1, 2, . . . , N, and N+1 are arranged in a row along the liquid crystal panel 200 and are connected in series. In other words, the data drivers 1, 2, . . . , N, and N+1 are connected in a cascade configuration.

Further, the timing controller 101 directly supplies display data (DATA), control signals (CASCADE and the like), a system clock (CLK) to each of the data drivers 1, 2, . . . , N, and N+1.

For example, the timing controller 101 supplies a cascade signal (CASCADE) as a control signal to a leading data driver 1. Note that the cascade signal is a timing signal specifying a timing when a data driver takes in display data.

Further, the timing controller 101 supplies a common timing signal (STB) as a control signal to each of the data drivers 1, 2, . . . , N, and N+1. Note that the common timing signal is a trigger signal specifying a timing when each of the data drivers 1, 2, . . . , N, and N+1 supplies its latched display data to the liquid crystal panel 200.

Further, upon receiving the cascade signal (CASCADE), each of the data drivers 1, 2, . . . , N, and N+1 successively latches the same number of display data pieces as the number of its own outputs. Then, after latching the same number of display data pieces as the number of its own outputs (display data of one line), each of the data drivers 1, 2, . . . , N, and N+1 supplies the cascade signal (CASCADE) to the subsequent stage of the data driver 1, 2, . . . , N, or N+1. In this way, the cascade signal (CASCADE) is transmitted to each of the data drivers 1, 2, . . . , N, and N+1 in a successive manner.

Further, in this first embodiment, an example where the numbers of outputs of the data drivers 1, 2, . . . , N, and N+1 are the same as each other is shown.

Further, each of the data drivers 1, 2, . . . , N, and N+1 latches display data of one line based on the input of the cascade signal (CASCADE). Then, after each of the data drivers 1, 2, . . . , N, and N+1 latches the display data of one line, the display data of one line is input from each of the data drivers 1, 2, . . . , N, and N+1 to the liquid crystal panel 200 based on the common timing signal (STB) supplied from the timing controller 101. In this way, the liquid crystal panel 200 displays the display data.

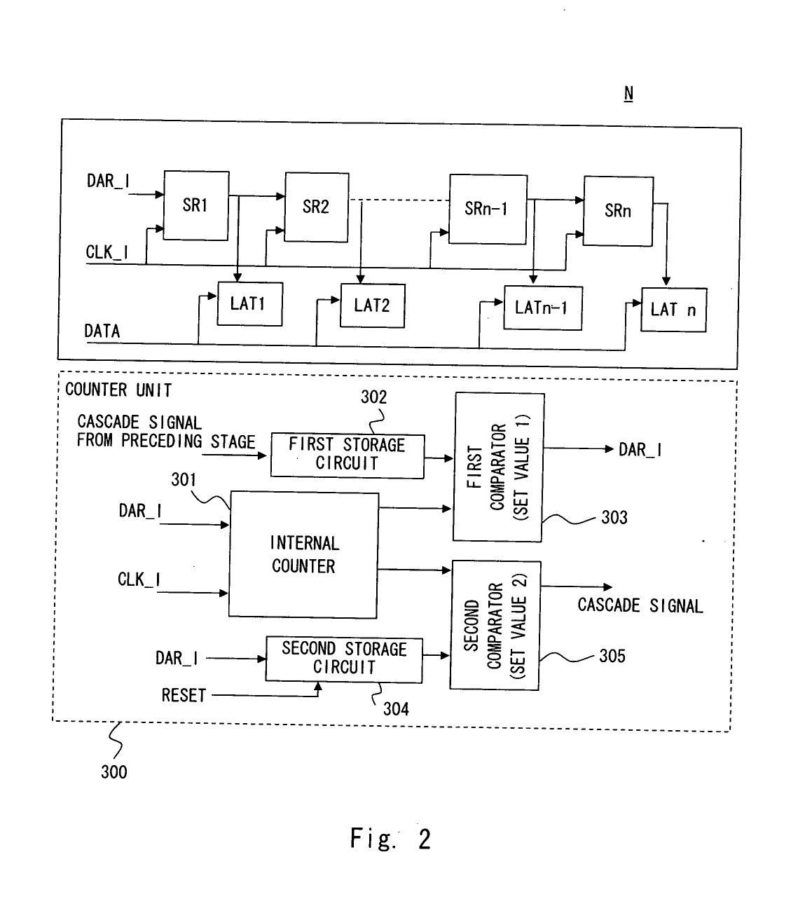

FIG. 2 is a block diagram showing an example of a configuration of the data drivers 1, 2, . . . , N, and N+1. In the following explanation, each of the data drivers 1, 2, . . . , N, and N+1 is simply referred to as “data driver N” unless the data drivers 1, 2, . . . , N, and N+1 need to be distinguished from each other.

As shown in FIG. 2, each data driver N includes shift registers SR1, SR2, . . . , SRn−1, and SRn (n is a positive integer), latch circuits LAT1, LAT2, . . . , LATn−1, and LATn, and a counter unit 300.

Further, the shift registers SR1, SR2, . . . , SRn−1, and SRn are connected in series. Further, the latch circuits LAT1, LAT2, . . . , LATn−1, and LATn are connected in series.

Further, the counter unit 300 includes a first storage circuit 302, a first comparator 303, a second storage circuit 304, and a second comparator 305.

The data driver N generates an internal clock (CLK_I) from the system clock (CLK) supplied from the timing controller 101. This internal clock (CLK_I) is a clock used to latch display data of one pixel. That is, the data driver N generates an internal clock (CLK_I) from the system clock (CLK) according to the display data format.

Then, the internal clock (CLK_I) is supplied to each of the shift registers SR1, SR2, . . . , SRn−1, and SRn and the internal counter 301.

An internal cascade signal (DAR_I) is input from the first comparator 303 to the internal counter 301. Further, the first signal of display data that is to be read into the first data driver 1 is also input to the internal counter 301. Further, the internal clock (CLK_I) is input to the internal counter 301. Then, the internal counter 301 is reset by the internal cascade signal (DAR_I) or the first signal of the display data that is to be read into the first data driver 1, and counts based on the internal clock (CLK_I).

Further, the maximum counter value of the internal counter 301 is larger than the number of outputs of the previous stage of the data driver N−1 and the number of outputs of the current stage of the data driver N.

Further, the internal counter 301 supplies the counter value to the first and second comparators 303 and 305.

A cascade signal is input from the timing controller 101 or the previous stage of the data driver N−1 to the first storage circuit 302. Further, the first storage circuit 302 is reset by the input of the cascade signal, and memorizes that the cascade signal has been input.

Further, a signal indicating that a cascade signal is input to the first storage circuit 302 is input from the first storage circuit 302 to the first comparator 303.

Upon receiving the signal indicating the input of the cascade signal from the first storage circuit 302, the first comparator 303 compares the counter value input from the internal counter 301 with a first set value. The first set value is the sum total of the numbers of outputs of the previous stage of the data drivers 1, 2, . . . , and N−1. Then, when the counter value input from the internal counter 301 becomes equal to the first set value, the first comparator 303 supplies an internal cascade signal (DAR_I) to the first shift register SR1. Next, the plurality of shift registers SR1, SR2, . . . , SRn−1, and SRn transmit the internal cascade signal (DAR_I) from one shift register to another. Then, the latch circuits LAT1, LAT2, . . . , LATn−1, and LATn latch the display data in response to the input of the internal cascade signals (DAR_I) from the corresponding shift registers SR1, SR2, . . . , SRn−1, and SRn.

Further, the first comparator 303 supplies the internal cascade signal (DAR_I) to the internal counter 301 and the second storage circuit 304.

The internal cascade signal (DAR_I) is also input from the first comparator 303 to the second storage circuit 304. Further, a cascade signal (CASCADE) is input from the second comparator 305 to the second storage circuit 304.

Further, the second storage circuit 304 retains the information that the first comparator 303 has output the internal cascade signal (DAR_I) until the cascade signal (CASCADE) is input from the second comparator 305 to the second storage circuit 304. Further, a signal indicating that the first comparator 303 has output the internal cascade signal (DAR_I) is input from the second storage circuit 304 to the second comparator 305.

Upon receiving the signal indicating the output of the internal cascade signal (DAR_I) from the first comparator 303 from the second storage circuit 304, the second comparator 305 compares the counter value input from the internal counter 301 with a second set value defined by Expression (1) shown below. Then, when the counter value input from the internal counter 301 becomes equal to the second set value, the second comparator 305 supplies a cascade signal (CASCADE) to the subsequent stage of the data driver N+1.

(second set value)=(number of outputs of current stage of data driver)−(delay clock number) (1)

In Expression (1), “delay clock number” is a value obtained by dividing the delay time of the cascade signal by the system clock (CLK) and rounding off the resultant value to the nearest whole number.

As described above, in the drive circuit 100 according to the first embodiment of the present invention, the internal counter 301 is reset at the timing when the first signal of the display data to be read is input to the first data driver 1.

Next, the readout operation of display data in the previous stage of the data driver N−1 and the counting operation of the internal counter 301 in the current stage of the data driver N are performed.

Further, a cascade signal (CASCADE) is input from the previous stage of the data driver N−1. Then, at the timing when the counter value of the internal counter 301 becomes equal to the first set value, i.e., at the timing when the previous stage of the data driver N−1 has completed the reading of the same number of display data pieces as the number of outputs of the data driver N−1, the internal counter 301 is reset and the current stage of the data driver N starts to take in display data.

Next, at the timing when the counter value of the internal counter 301 becomes equal to the second set value, i.e., at the timing that is in advance by an amount equivalent to the compensation clock number corresponding to the delay time of the cascade signal, the cascade signal is output to the subsequent stage of the data driver N+1.

In this manner, the subsequent stage of the data driver N+1 can reset the internal counter 301 and start the counting operation at the timing that is in advance by an amount equivalent to the delay time of the cascade signal regardless of the relation between the delay time of the cascade signal and the clock cycle of the system clock (CLK).

Therefore, the subsequent stage of the data driver N+1 can start to read display data at a proper timing regardless of the relation between the delay time of the cascade signal and the clock cycle of the system clock (CLK).

Accordingly, even when the delay time of the cascade signal is larger than the clock cycle of the system clock (CLK), it is still possible to maintain the continuity of display data between the data driver N and the data driver N+1.

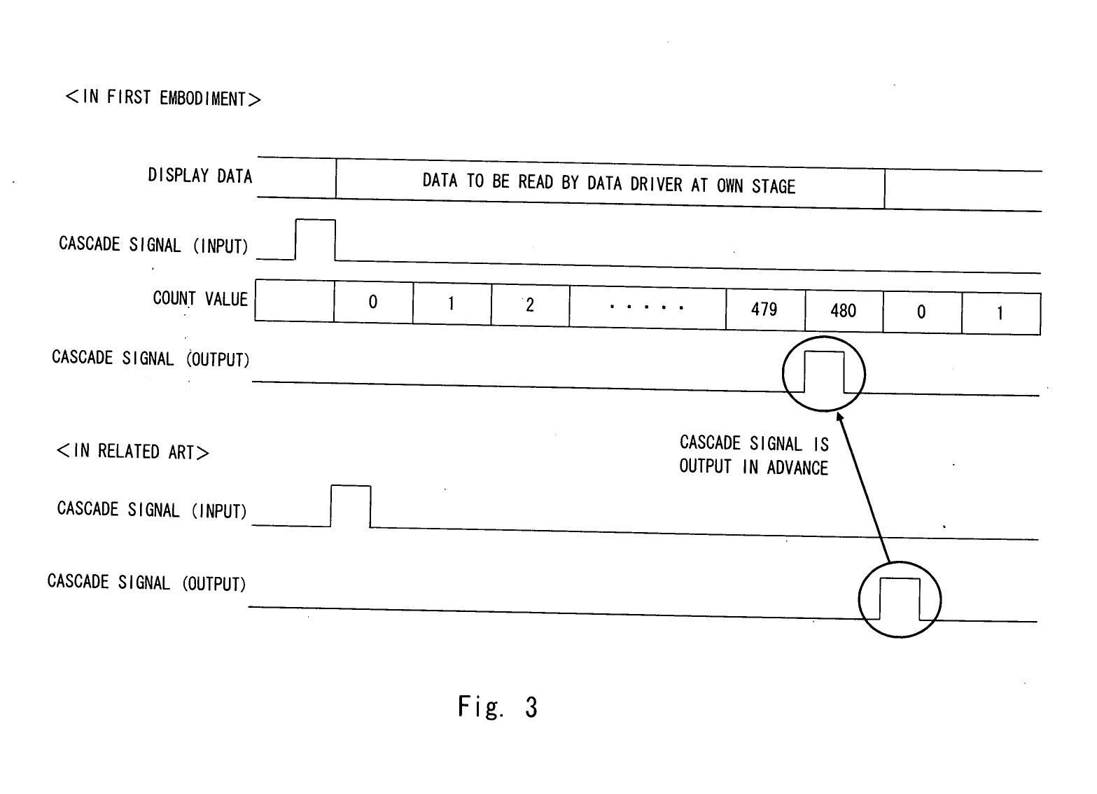

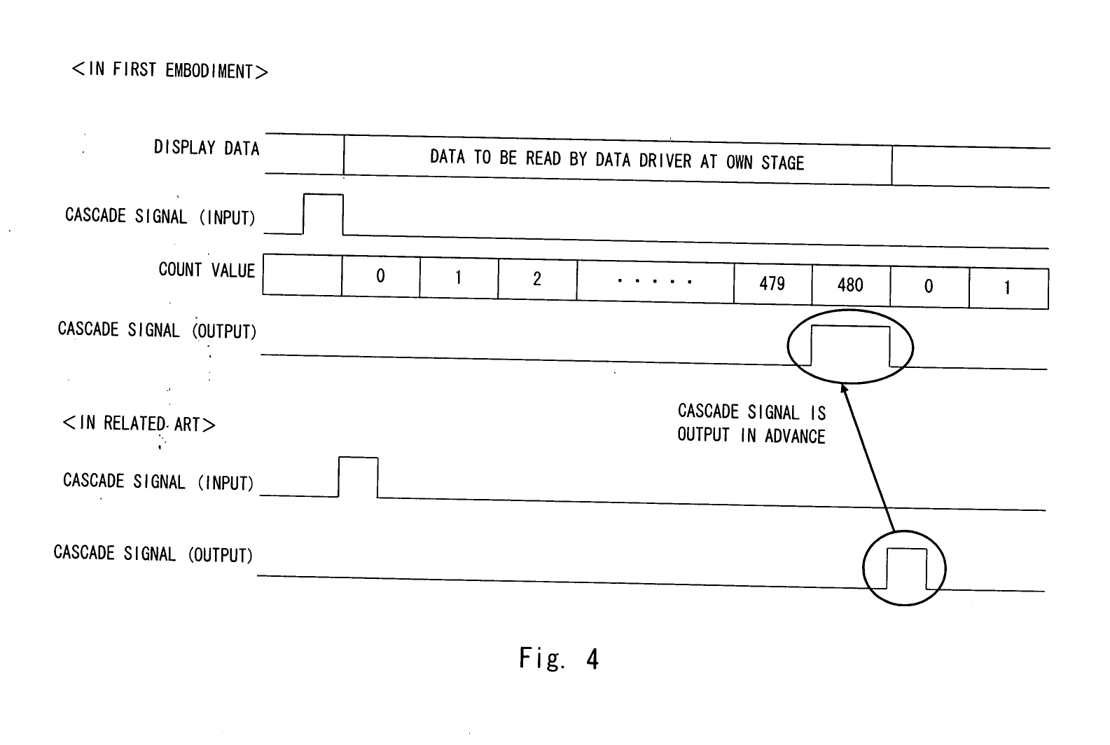

Next, a relation between input/output timings of a cascade signal to a data driver N and the counter value of an internal counter 301 in the drive circuit 100 according to the first embodiment of the present invention is explained with reference to FIGS. 3 and 4.

The upper parts of FIGS. 3 and 4 are a timing chart showing input/output timings of a cascade signal and the counter value of an internal counter 301 in the drive circuit 100 according to the first embodiment. Further, the lower parts of FIGS. 3 and 4 are a timing chart showing input/output timings of a cascade signal in a drive circuit in the related art.

Note that in FIGS. 3 and 4, the number of outputs of each data driver is 720. Further, in FIGS. 3 and 4, the interface of each data driver is a mini-LVDS interface. Therefore, each data driver can receive an amount of input data corresponding to six outputs in parallel. Therefore, in FIGS. 3 and 4, when the cycle of the internal clock (CLK_I) corresponds to one-fourth frequency (8 bits), the counter value that the internal counter 301 counts before the data driver has completed the reading of the same number of display data pieces as the number of outputs of the data driver itself is calculated by an expression “(counter value)=(number of outputs)× 4/6”. Therefore, when the number of outputs of the data driver is 720, the counter value that the internal counter 301 counts before the data driver has completed the reading of the same number of display data pieces as the number of outputs of the data driver itself is 480. That is, in FIGS. 3 and 4, the first set value is 480.

As shown in FIG. 3, in the drive circuit in the related art, after the data driver reads the same number of display data pieces as the number of outputs of the data driver itself, the data driver outputs a cascade signal (CASCADE) to the subsequent stage of the data driver. As a result, when the delay time of the cascade signal (CASCADE) is larger than the clock cycle of the system clock (CLK), the subsequent stage of the data driver starts to read display data at a timing that is later than the original (proper) timing.

In contrast to this, in the drive circuit 100 according to the first embodiment of the present invention, even when the data driver N is still reading the same number of display data pieces as the number of outputs of the data driver itself, the cascade signal (CASCADE) is output to the subsequent stage of the data driver N+1 when the counter value of the internal counter 301 reaches the second set value (which is 479 in the example shown in FIG. 3). In the example shown in FIG. 3, the cascade signal (CASCADE) is output to the subsequent stage of the data driver N+1 one clock earlier than the related art. As a result, it is possible to supply the cascade signal (CASCADE) to the subsequent stage of the data driver N+1 in advance by an amount equivalent to the delay time of the cascade signal (CASCADE). That is, the subsequent stage of the data driver N+1 can start to read display data at the original (proper) timing regardless of the relation between the delay time of the cascade signal (CASCADE) and the clock cycle of the system clock (CLK).

Further, as shown in FIG. 4, it is also possible to advance the timing when the cascade signal (CASCADE) is output from the current stage of the data driver N by an amount equivalent to the delay time of the cascade signal (CASCADE) as in the case shown in FIG. 3, and to stop the output of the cascade signal (CASCADE) from the current stage of the data driver N at the same timing as that in the related art. In this case, it is also possible to supply the cascade signal (CASCADE) to the subsequent stage of the data driver N+1 at a proper timing not only when the clock frequency of the system clock (CLK) is high as in the case shown in FIG. 3, but also when the clock frequency of the system clock (CLK) is so low that the delay time of the cascade signal (CASCADE) does not cause any substantial problem.

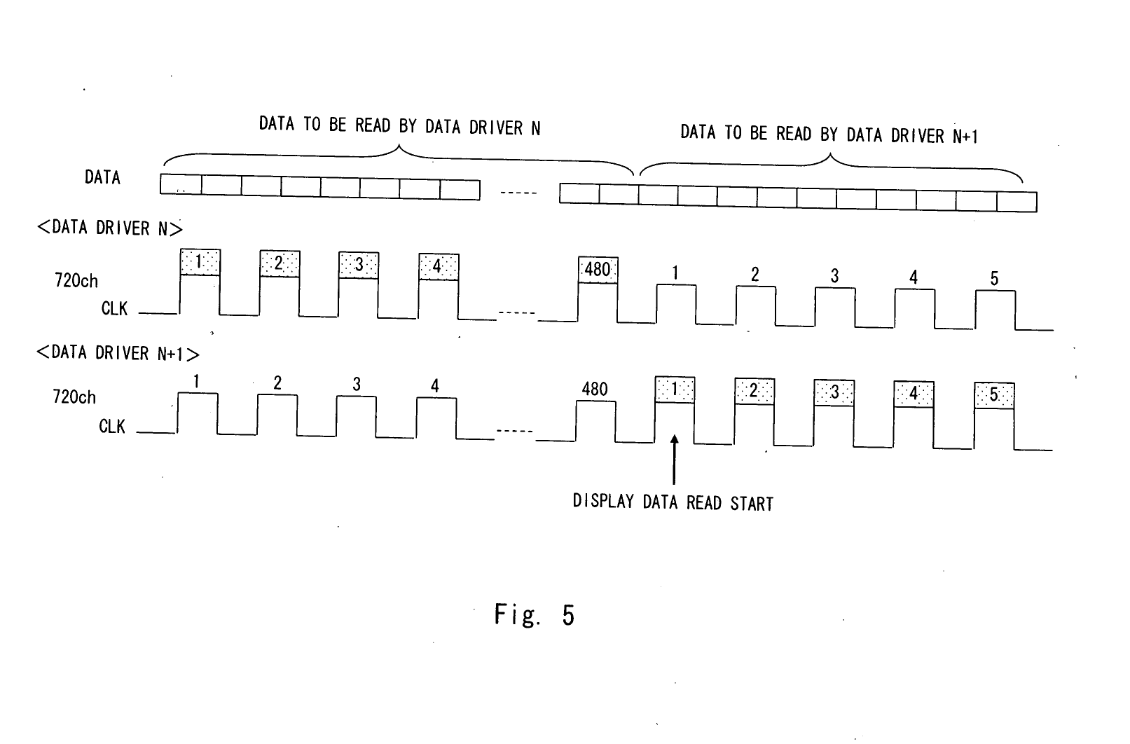

FIG. 5 is a timing chart showing a relation between display data read timings in a data driver N and a data drive'r N+1 and the counter value of an internal counter 301 according to the first embodiment of the present invention.

In FIG. 5, the number of outputs of each of the data driver N and the data driver N+1 is 720. Therefore, the counter value that the internal counter 301 counts before the respective data driver N or N+1 has completed the reading of the same number of display data pieces as the number of outputs of that data driver itself is 480. That is, in FIG. 5, the first set value of the data driver N+1 is 480. Further, when the delay time of the cascade signal (CASCADE) is smaller than the clock cycle of the system clock (CLK), the second set value of the data driver N+1 is also 480.

Note that in FIG. 5, the clocks indicated by the hatching pattern are clocks when the reading of display data is performed. Further, the data recognition signal, which is added at the front of the display data to be read into the first data driver 1, is used as the common timing signal used to reset the internal counter 301 of each of the data drivers N and N+1. That is, the internal counters 301 of all the data drivers 1, 2, . . . , N, and N+1 are reset and start counting operations at a timing when the first data driver 1 reads the leading data of the display data.

Further, as shown in FIG. 5, as the readout operation of display data and the counting operation of the internal counter 301 are started in the data driver N, the counting operation of the internal counter 301 in the subsequent stage of the data driver N+1 is also started.

Next, when both of the counter values of the internal counters 301 of the data drivers N and N+1 become 480, a cascade signal (CASCADE) is input from the data driver N to the data driver N+1 and the internal counters 301 of the data drivers N and N+1 are reset.

At the same time, the reading of the display data in the data driver N is stopped, and the reading of the display data in the data driver N+1 is started.

Since the numbers of outputs of the data drivers N and N+1 are same as each other and the set values of the data drivers N and N+1 are also same as each other, the continuity of read display data is maintained between the data drivers N and N+1.

As explained above, according to the drive circuit 100 in accordance with the first embodiment of the present invention, the internal counters 301 of all the data drivers 1, 2, . . . , N, and N+1 are reset at the timing when the first data driver 1 starts to read the display data. Therefore, the counting operation of the internal counter 301 in the current stage of the data driver N is performed simultaneously with the readout operation of the display data and the counting operation of the internal counter 301 performed in the previous stage of the data driver N−1.

Next, when the cascade signal (CASCADE) is input from the previous stage of the data driver N−1 and the counter value of the internal counter 301 in the current stage of the data driver N becomes equal to the first set value, that internal counter 301 is reset and the reading of display data in the current stage of the data driver N starts. In this way, it is possible to start the reading of display data in the current stage of the data driver N at the timing when the reading of display data in the previous stage of the data driver N−1 has finished. Further, the count operation by the internal counter 301 starts at the timing when the reading of display data in the current stage of the data driver N starts.

Next, when the counter value of the internal counter 301 of the current stage of the data driver N becomes equal to the second set value, the counter unit 300 supplies a cascade signal to the subsequent stage of the data driver N+1. Since the delay clock number of the cascade signal (CASCADE) is taken into account in the second set value, the counter unit 300 can supply the cascade signal (CASCADE) to the subsequent stage of the data driver N+1 at a timing that is in advance by an amount equivalent to the delay clock number of the cascade signal (CASCADE).

In other words, the counter unit 300 can supply the cascade signal (CASCADE) to the subsequent stage of the data driver N+1 in advance by an amount equivalent to the delay time of the cascade signal (CASCADE). In this way, the subsequent stage of the data driver N+1 can start to read display data at the original (proper) timing regardless of the relation between the delay time of the cascade signal (CASCADE) and the clock cycle of the system clock (CLK). Therefore, it is possible to maintain the continuity of display data among the data drivers 1, 2, . . . , and N.

### Second Embodiment

A drive circuit according to a second embodiment of the present invention is modified from the drive circuit 100 according to the first embodiment so that the continuity of the display data among the data drivers 1, 2, . . . , N, and N+1 can be maintained even when the numbers of outputs are different among the data drivers 1, 2, . . . , N, and N+1.

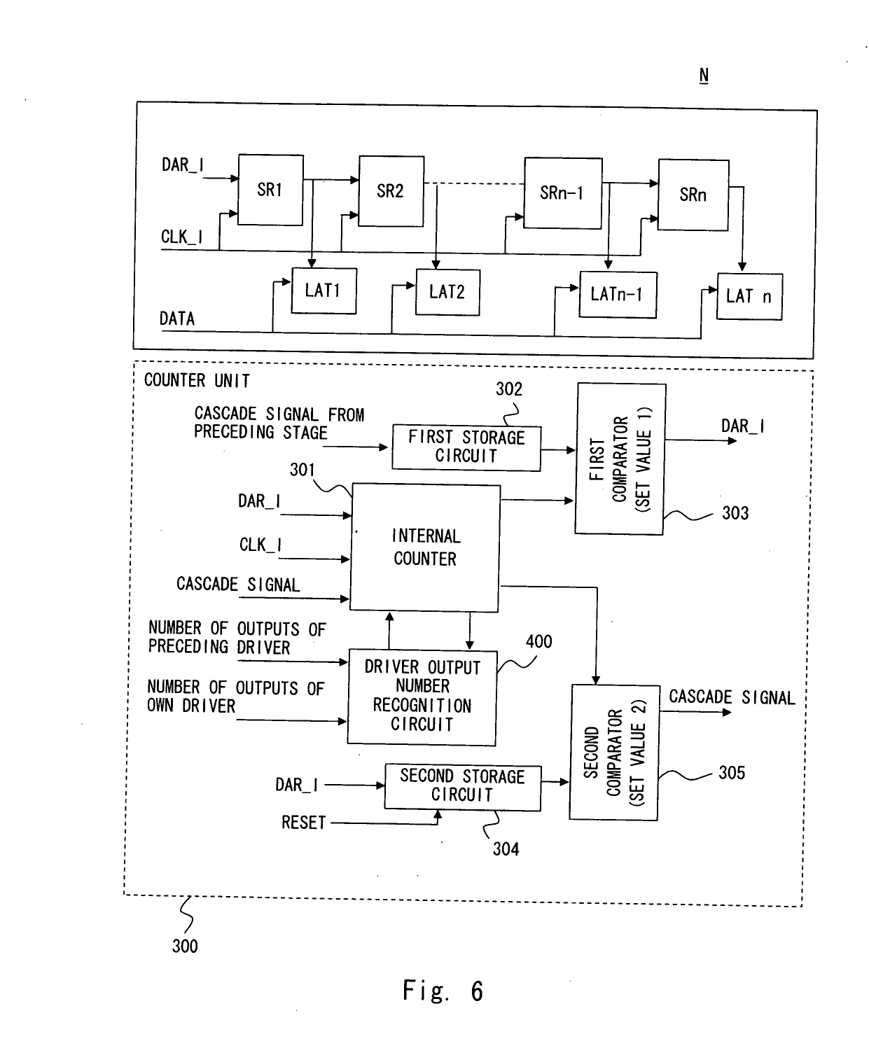

FIG. 6 is a block diagram showing an example of a configuration of data drivers 1, 2, . . . , N, and N+1 according to the second embodiment of the present invention.

As shown in FIG. 6, the data drivers 1, 2, . . . , N, and N+1 of a drive circuit according to the second embodiment are different from the data drivers 1, 2, . . . , N, and N+1 according to the first embodiment in that each of the data drivers 1, 2, . . . , N, and N+1 according to the second embodiment includes a driver output number recognition circuit 400. Accordingly, the same structures as those of the first embodiment are denoted by the same symbols and their explanation is omitted.

An internal counter 301 is different from that of the first embodiment in that the internal counter 301 receives a carry signal and a cascade signal (CASCADE) supplied from the driver output number recognition circuit 400 in addition to the internal cascade signal (DAR_I), the first signal of display data to be read into the first data driver 1, and the internal clock (CLK_I).

Further, the internal counter 301 is also different from that of the first embodiment in that the internal counter 301 is reset not only by the internal cascade signal (DAR_I) but also by the carry signal and the cascade signal (CASCADE).

Note that the carry signal is a signal used to reset the internal counter 301 according to the number of outputs of the respective one of the data drivers 1, 2, . . . , N, and N+1.

Further, the internal counter 301 is also different from that of the first embodiment in that the internal counter 301 supplies its counter value not only to the first and second comparators 303 and 305 but also to the driver output number recognition circuit 400.

The driver output number recognition circuit 400 receives a pulse signal indicating the numbers of outputs of the data drivers 1, 2, . . . , and N−1 preceding the current stage of the data driver N and a pulse signal indicating the number of outputs of the current stage of the data driver N. The pulse signal indicating the numbers of outputs of the data drivers 1, 2, . . . , and N−1 preceding the current stage of the data driver N and the pulse signal indicating the number of outputs of the current stage of the data driver N are transmitted together with the cascade signal.

Then, the driver output number recognition circuit 400 recognizes the numbers of outputs of the data drivers 1, 2, . . . , and N−1 preceding the current stage of the data driver N based on the pulse signal indicating the numbers of outputs of the data drivers 1, 2, . . . , and N−1 preceding the current stage of the data driver N. Further, the driver output number recognition circuit 400 resets the internal counter 301 of the current stage of the data driver N at the same timing as that of the internal counters 301 of the data drivers 1, 2, . . . , and N−1 preceding the current stage of the data driver N based on the numbers of outputs of the data drivers 1, 2, . . . , and N−1 preceding the current stage of the data driver N.

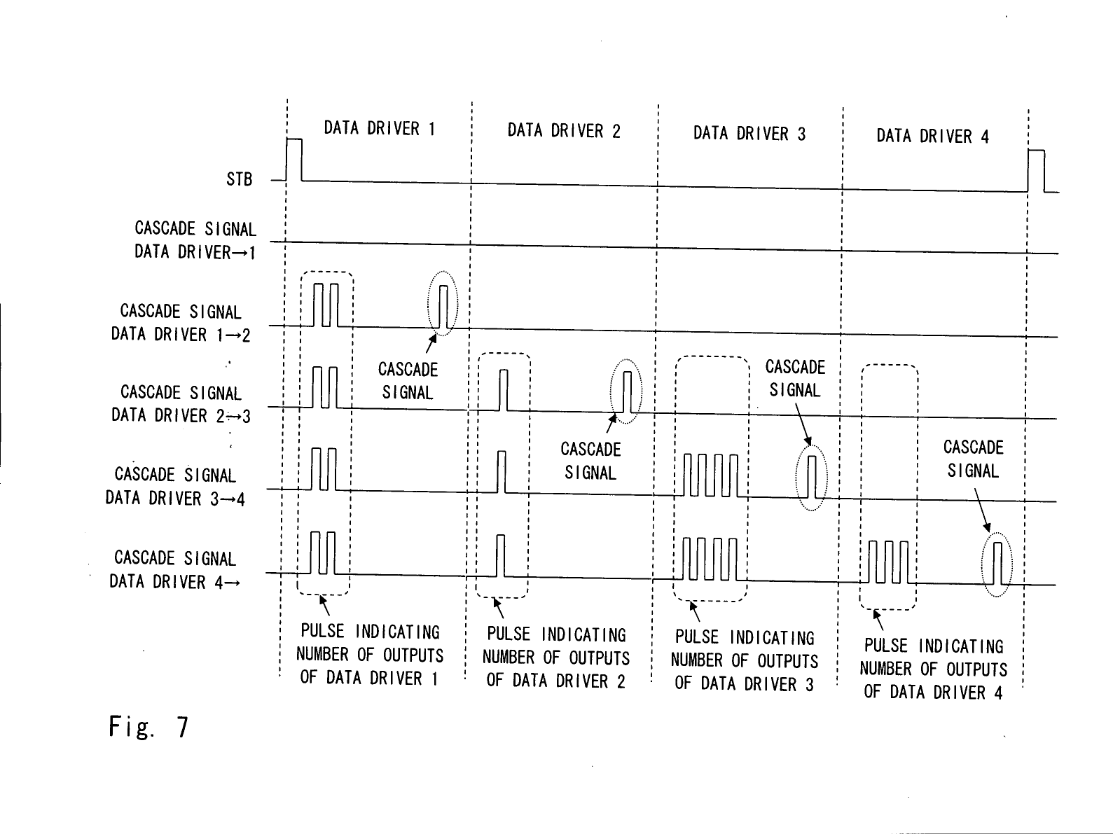

FIG. 7 is a timing chart showing input/output timings of a cascade signal (CASCADE) in each of the data drivers 1, 2, . . . , N, and N+1 of a drive circuit according to the second embodiment of the present invention.

For simplifying the explanation, FIG. 7 shows a case where four data drivers 1, 2, 3 and 4 are connected in a cascade configuration. Further, in FIG. 7, each of the sections denoted as “driver 1”, “driver 2”, “driver 3”, and “driver 4” indicates a period in which a respective one of the data drivers 1, 2, 3 and 4 receives a cascade signal (CASCADE), starts to read display data, finishes the reading of the same number of display data pieces as the number of outputs of the current stage of the data driver 1, 2, 3 or 4, and supplies a cascade signal (CASCADE) to the subsequent stage of the data driver. Further, the numbers of the outputs of the data drives 1, 2, 3 and 4 are different from each other.

As shown in FIG. 7, in the drive circuit according to the second embodiment, a pulse signal indicating the number of outputs of the data driver 1 is transmitted to the data drives 2, 3 and 4. In other words, the data driver 1 outputs a pulse signal indicating the number of outputs of that data driver 1 to all of the data drives connected subsequent to that data driver 1 in a cascade configuration.

Similarly, a pulse signal indicating the number of outputs of the data driver 2 is transmitted to the data drives 3 and 4 that are connected subsequent to that data driver 2 in a cascade configuration. Further, a pulse signal indicating the number of outputs of the data driver 3 is transmitted to the data driver 4 that is connected subsequent to that data driver 3 in a cascade configuration.

In this way, it is possible to synchronize the operation timings of the internal counters 301 of all the data drives 1, 2, 3 and 4 with each other.

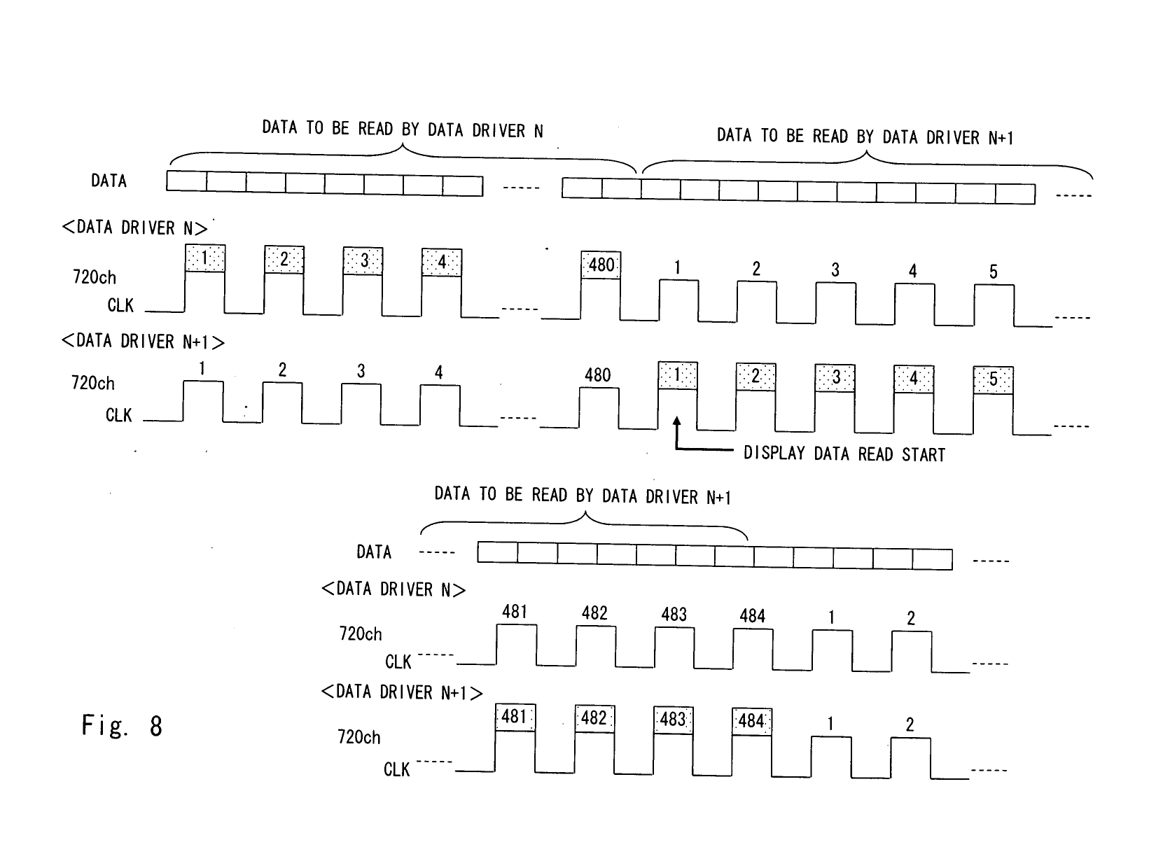

FIG. 8 is a timing chart showing an operation of an internal counter 301 according to the second embodiment of the present invention. The upper part of FIG. 8 shows counter values of the internal counter 301 of a data driver N and the lower part of FIG. 8 shows counter values of the internal counter 301 of a data driver N+1 subsequent to the data driver N.

Further, in FIG. 8, the number of outputs of the data driver N is 720, and therefore the counter value that the internal counter 301 counts before the data driver N has completed the reading of the same number of display data piece as the number of outputs of the data driver N itself is 480. That is, in FIG. 8, the first set value of the data driver N+1 is 480.

Further, in FIG. 8, the number of outputs of the data driver N+1 is 726, and therefore the counter value that the internal counter 301 counts before the data driver N+1 has completed the reading of the same number of display data pieces as the number of outputs of the data driver N+1 itself is 484. Further, when the delay time of the cascade signal (CASCADE) is smaller than the clock cycle of the system clock (CLK), the second set value of the data driver N+1 is also 484.

Note that in FIG. 8, the clocks indicated by the hatching pattern are clocks when the reading of display data is performed.

Further, the data recognition signal, which is added at the front of the display data to be read into the first data driver 1, is used as the common timing signal used to reset the internal counter 301 of each of the data drivers N and N+1. That is, the internal counters 301 of all the data drivers 1, 2, . . . , N, and N+1 are reset and start counting operations at a timing when the first data driver 1 reads the leading data of the display data.

Further, as shown in FIG. 8, as the readout operation of display data and the counting operation of the internal counter 301 are started in the data driver N, the counting operation of the internal counter 301 in the subsequent stage of the data driver N+1 is also started.

Next, when both of the counter values of the internal counters 301 of the data drivers N and N+1 become 480, a cascade signal (CASCADE) is input from the data driver N to the data driver N+1 and the internal counters 301 of the data drivers N and N+1 are reset.

At the same time, the reading of the display data in the data driver N is stopped, and the reading of the display data in the data driver N+1 is started.

Next, when the counter value of the internal counter 301 of the subsequent stage of the data driver N+1 becomes 484, the reading of the display data in the data driver N+1 is stopped.

As described above, even when the numbers of outputs of the data drivers N and N+1 are different, the driver output number recognition circuit 400 of the data driver N+1 recognizes the number of outputs of the data driver N and thereby resets the internal counter 301 of the data driver N+1 at the same timing as that of the internal counter 301 of the data driver N. Therefore, the continuity of read display data is maintained between the data drivers N and N+1.

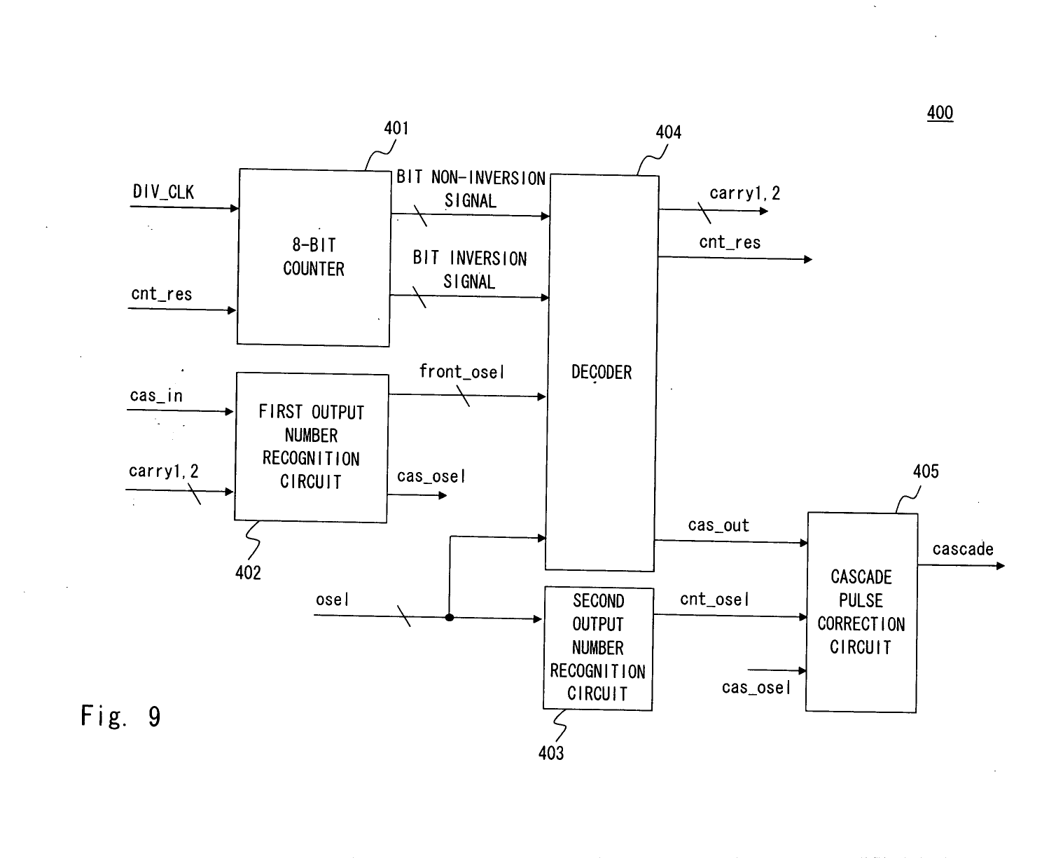

FIG. 9 is a block diagram showing an example of a configuration of the driver output number recognition circuit 400 according to the second embodiment of the present invention.

As shown in FIG. 9, the driver output number recognition circuit 400 includes an 8-bit counter 401, a first output number recognition circuit 402, a second output number recognition circuit 403, a decoder 404, a cascade pulse correction circuit 405, and the like.

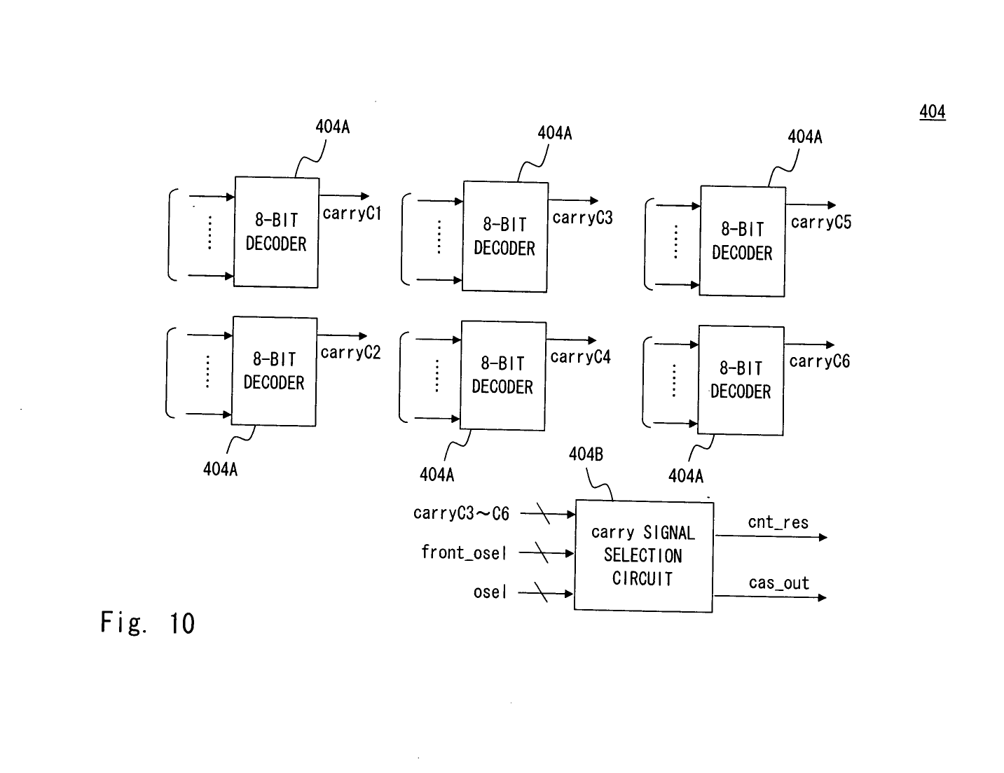

Further, FIG. 10 is a block diagram showing an example of a configuration of the decoder 404 according to the second embodiment of the present invention.

As shown in FIG. 10, the decoder 404 includes 8-bit decoders (8 bit DEC) 404A, . . . , and a carry signal selection circuit 404B and the like.

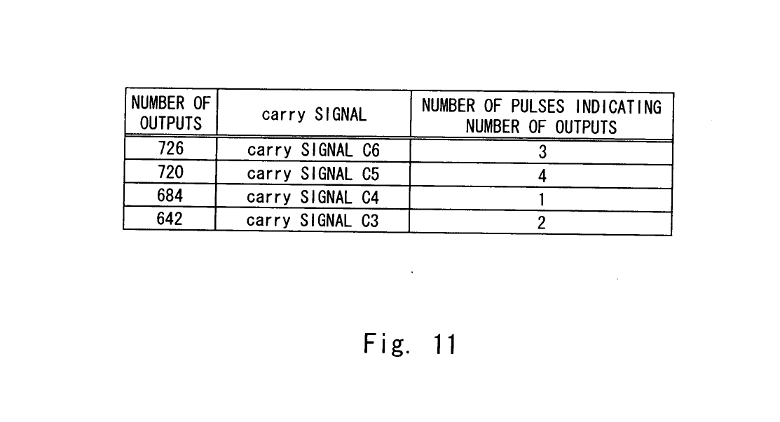

Note that the carry signal C1 and the carry signal C2 are signals specifying sections in which the numbers of outputs of the data drivers 1, 2, . . . , and N−1 preceding the current stage of the data driver N are recognized. Therefore, when there are m different numbers of outputs (m is a positive integer) for the data drivers 1, 2, . . . , and N−1, carry signals C3 to Cm+2 are prepared. In other words, one carry signal is prepared for each of the different numbers of outputs. FIG. 11 shows an example of a relation among the numbers of outputs, carry signals, and the numbers of pulses indicating the respective numbers of outputs.

FIGS. 9, 10 and 11 shows a case where there are four different numbers of outputs.

A frequency-division clock signal (DIV_CLK) and an internal signal (cnt_res) are input to the 8-bit counter 401.

Then, the 8-bit counter 401 supplies a bit non-inversion signal and a bit inversion signal to the decoder 404.

Specifically, the 8-bit counter 401 is a counter circuit that counts up at rising edges of the frequency-division clock (DIV_CLK). Further, the 8-bit counter 401 is reset by the input of the internal signal (cnt_res). Then, the 8-bit counter 401 supplies a bit non-inversion signal and a bit inversion signal to the decoder 404 as a value corresponding to the counter value at each cycle of the frequency-division clock (DIV_CLK).

A cascade signal (cas_in) and carry signals C1, C2, . . . corresponding to the numbers of outputs of the data drivers 1, 2, . . . , and N−1 preceding the current stage of the data driver N are input to the first output number recognition circuit 402.

Then, the first output number recognition circuit 402 recognizes the numbers of outputs of the data drivers 1, 2, . . . , and N−1 preceding the current stage of the data driver N based on the carry signals C1, C2, . . . and supplies that information (front_osel) to the decoder 404.

Further, the first output number recognition circuit 402 supplies an internal signal (cas_osel) to the cascade pulse correction circuit 405.

A pulse signal (osel) indicating the number of outputs of the current stage of the data driver N is input to the second output number recognition circuit 403. This pulse signal (osel) indicating the number of outputs of the current stage of the data driver N is a signal that can be individually set from the outside of the data driver N.

Then, the second output number recognition circuit 403 recognizes the number of outputs of the current stage of the data driver N based on the pulse signal (osel) indicating the number of outputs of the current stage of the data driver N and supplies that information (cnt_osel) to the cascade pulse correction circuit 405.

The bit non-inversion signal and the bit inversion signal are input from the 8-bit counter 401 to the decoder 404.

Further, the information (front_osel) about the numbers of outputs of the data drivers 1, 2, . . . , and N−1 preceding the current stage of the data driver N is input from the first output number recognition circuit 402 to the decoder 404.

Further, the pulse signal (osel) indicating the number of outputs of the current stage of the data driver N is also input to the decoder 404.

Then, each of the 8-bit decoders 404A of the decoder 404 selects one of the bit non-inversion signal and the bit inversion signal on a bit-by-bit basis. In this way, eight bits composed of a combination of bit non-inversion signals and bit inversion signals are input to each of the 8-bit decoders 404A.

The combinations of bit non-inversion signals and bit inversion signals input to all of the 8-bit decoders 404A are different from each other. Further, each of the 8-bit decoders 404A selects a bit non-inversion signal or a bit inversion signal on a bit-by-bit basis so that it outputs a set carry signal at a set counter value. Then, each of the 8-bit decoders 404A supplies a carry signal corresponding to the combination of bit non-inversion signals and bit inversion signals supplied to that 8-bit decoder 404A to the carry signal selection circuit 404B

The carry signals C3, C4, C5 and C6 are input from the 8-bit decoders 404A to the carry signal selection circuit 404B.

Then, the carry signal selection circuit 404B recognizes the numbers of outputs of the data drivers 1, 2, . . . , and N−1 preceding the current stage of the data driver N based on the information (front_osel) about the numbers of outputs of the data drivers 1, 2, . . . , and N−1 preceding the current stage of the data driver N. Next, the carry signal selection circuit 404B selects a carry signal corresponding to the recognized number of outputs and supplies the selected carry signal (cas_out) to the cascade pulse correction circuit 405.

Further, the decoder 404 supplies the carry signal C1, C2, . . . generated by the 8-bit decoders 404A and the internal signal (cnt_res) to the internal counter 301.

The carry signal (cas_out) is input from the carry signal selection circuit 404B of the decoder 404 to the cascade pulse correction circuit 405.

Further, the internal signal (cas_osel) is input from the first output number recognition circuit 402 to the cascade pulse correction circuit 405.

Further, the information (cnt_osel) about the number of outputs of the current stage of the data driver N is input from the second output number recognition circuit 403 to the cascade pulse correction circuit 405.

Then, the cascade pulse correction circuit 405 generates a cascade signal (CASCADE) based on the carry signal, the internal signal (cas_osel), and the information (cnt_osel) about the number of outputs of the current stage of the data driver N, and supplies the generated cascade signal (CASCADE) to the second comparator 305 through the internal counter 301.

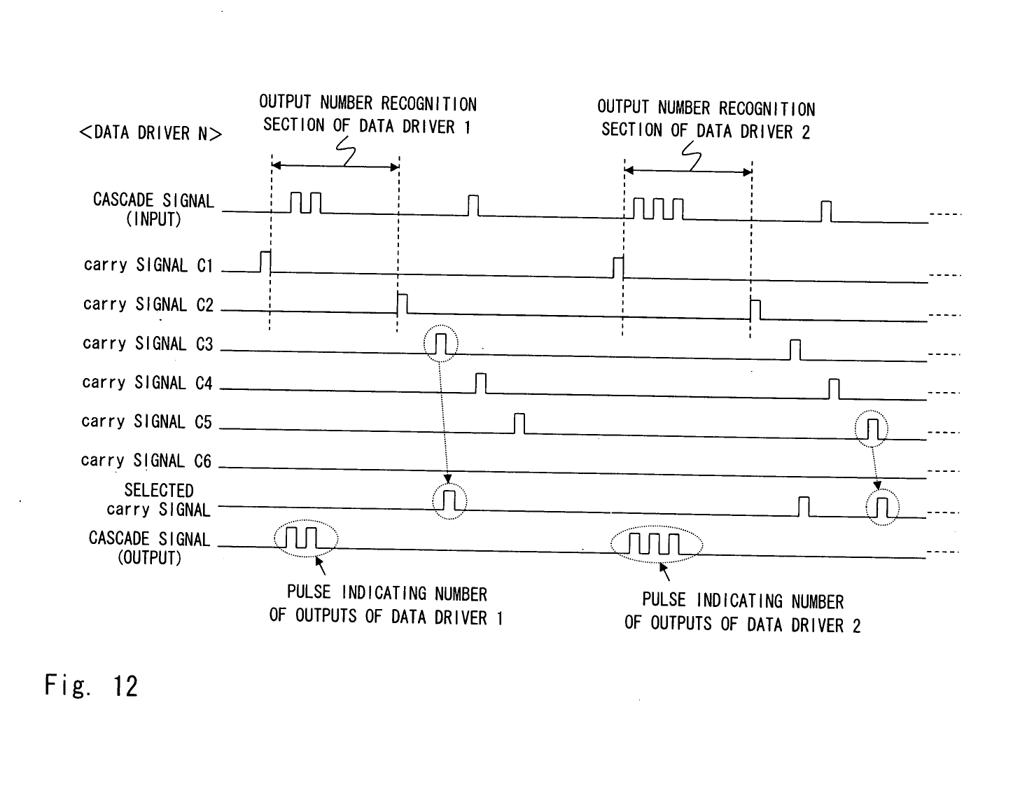

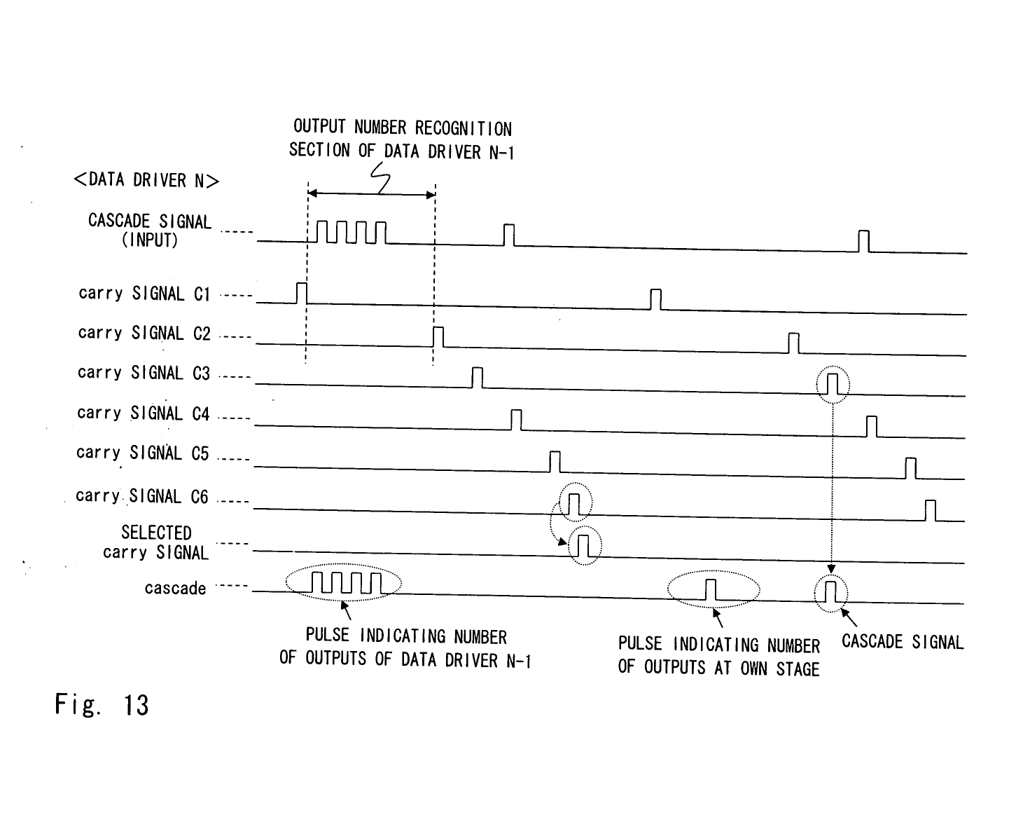

FIGS. 12 and 13 are a timing chart showing an operation in the driver output number recognition circuit 400 of the data driver N.

As shown in FIGS. 12 and 13, the period between when the carry signal C1 is input and when the carry signal C2 is input becomes the section in which the number of outputs of the data driver 1, 2, . . . , or N−1 preceding the current stage of the data driver N is recognized. In this section, the first output number recognition circuit 402 recognizes the number of outputs of the data driver 1, 2, . . . , or N−1 preceding the current stage of the data driver N is recognized based on the pulse signal indicating the number of outputs of the data driver 1, 2, . . . , or N−1 preceding the current stage of the data driver N.

Next, the 8-bit decoders 404A of the decoder 404 output carry signals C3, C4, C5 and C6.

Then, the carry signal selection circuit 404B of the decoder 404 selects one of the carry signals and outputs the selected carry signal.

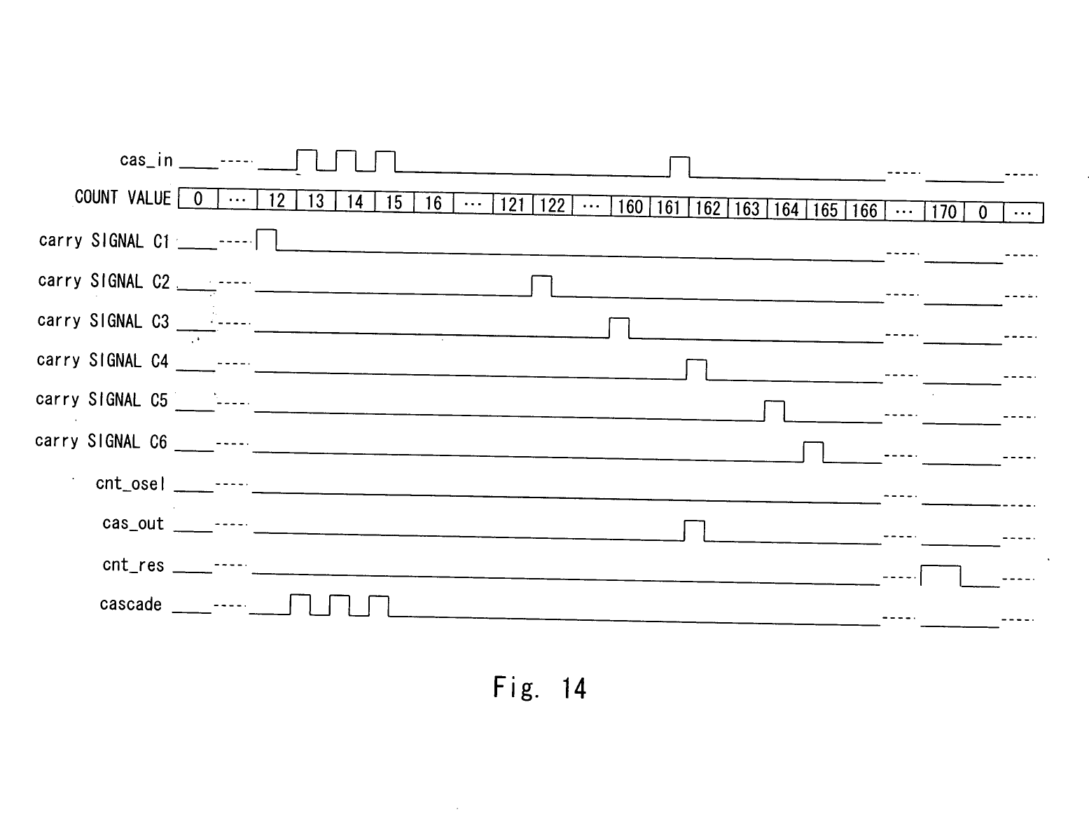

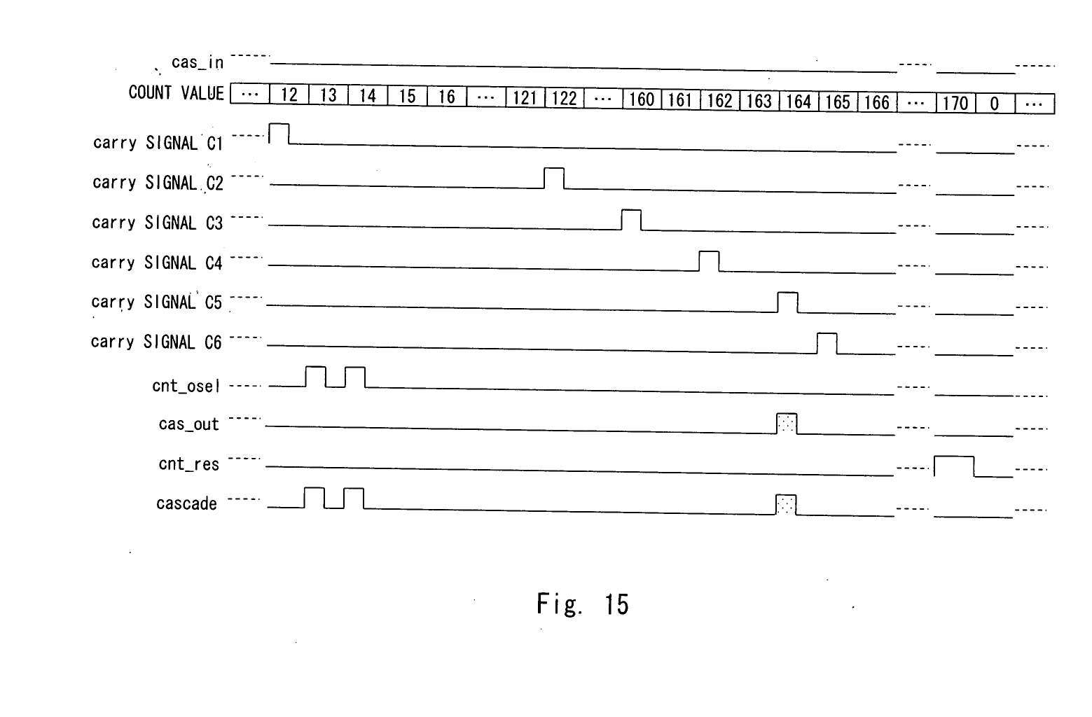

FIGS. 14 and 15 are a timing chart showing an operation in a certain data driver N connected in a cascade configuration.

In FIGS. 14 and 15, a signal “cas_in” is a cascade signal (CASCADE) input to the data driver N. Further, a signal “cas_out” is a carry signal that is selected and output by the carry signal selection circuit 404B. Further, a signal “cnt_res” is an internal signal used to reset the 8-bit counter 401.

As shown in FIGS. 14 and 15, the driver output number recognition circuit 400 of the data driver N recognizes the numbers of outputs of the data drivers 1, 2, . . . , and N−1 in the order of data driver 1, data driver 2, . . . , and data driver N−1.

Then, every time the driver output number recognition circuit 400 of the data driver N recognizes the number of the outputs of the data driver 1, 2, . . . , or N−1, the driver output number recognition circuit 400 resets the internal counter 301 by supplying a carry signal corresponding to the recognized number of outputs to the internal counter 301.

For example, in the example shown in FIGS. 14 and 15, the 8-bit decoders 404A output a carry signal C1 when the counter value of the internal counter 301 is 12, output a carry signal C2 when the counter value of the internal counter 301 is 122, output a carry signal C3 when the counter value of the internal counter 301 is 160, output a carry signal C4 when the counter value of the internal counter 301 is 162, output a carry signal C5 when the counter value of the internal counter 301 is 164, and output a carry signal C6 when the counter value of the internal counter 301 is 165.

Further, the carry signal selection circuit 404B selects, for example, the carry signal C4 output from the 8-bit decoders 404A when the counter value of the internal counter 301 is 162, and supplies the selected carry signal C4 to the cascade pulse correction circuit 405.

Then, that carry signal C4 is input from the cascade pulse correction circuit 405 to the internal counter 301, and therefore the internal counter 301 is reset.

Next, a cascade signal (CASCADE) is generated by the cascade pulse correction circuit 405 and input to the internal counter 301.

Then, when the cascade signal (CASCADE) is input from the cascade pulse correction circuit 405 to the internal counter 301, the internal counter 301 is reset and the data driver N starts to read display data.

Further, the second comparator 305 adds a pulse signal indicating the numbers of outputs of the data drivers 1, 2, . . . , and N to the cascade signal (CASCADE), and supplies the resultant cascade signal (CASCADE) to the subsequent stage of the data driver N+1.

As explained above, according to the second embodiment of the present invention, even when the numbers of outputs are different among the data drivers 1, 2, . . . , and N, the driver output number recognition circuit 400 resets the internal counter 301 of the current stage of the data driver N at the same timing as that of the internal counters 301 of the data drivers 1, 2, . . . , and N−1 preceding the current stage of the data driver N based on the numbers of outputs of the data drivers 1, 2, . . . , and N−1 preceding the current stage of the data driver N. Therefore, it is possible to synchronize the operation timings of the internal counters 301 of the data drivers 1, 2, . . . , and N with each other. Therefore, even when the numbers of outputs are different among the data drivers 1, 2, . . . , and N, it is possible to maintain the continuity of display data among the data drivers 1, 2, . . . , N, and N+1.

Note that the present invention is not limited to the above-described embodiments, and various modifications can be made as appropriate without departing from the spirit and scope of the present invention. For example, the display device is not limited to liquid crystal panels.

While the invention has been described in terms of several embodiments, those skilled in the art will recognize that the invention can be practiced with various modifications within the spirit and scope of the appended claims and the invention is not limited to the examples described above.

The first and second embodiments can be combined as desirable by one of ordinary skill in the art.

Further, the scope of the claims is not limited by the embodiments described above.

Furthermore, it is noted that, Applicant's intent is to encompass equivalents of all claim elements, even if amended later during prosecution.

What is claimed is:

1. A drive circuit of a display device comprising a plurality of data drivers connected in series, wherein
the plurality of data drivers successively read display data to be output to the display device,
each of the data drivers comprises a counter unit,
each of the counter units comprises an internal counter that counts based on an internal clock,
a common timing signal is input to the data drivers at a timing when a data driver at a first stage reads a first signal of the display data, and the internal counters are thereby reset,
when a cascade signal specifying a timing when readout of the display data is performed is input from a previous stage of the data driver to a current stage of the data driver and a counter value of the internal counter becomes equal to a first set value, the internal counter is reset and readout of the display date in the current stage of the data driver starts, the first set value being a number of outputs of the previous stage of the data driver,
when the counter value becomes equal to a second set value, the counter unit supplies the cascade signal to a subsequent stage of the data driver, and
when a delay clock number of the cascade signal is defined as a value obtained by dividing a delay time of the cascade signal by a system clock and rounding off the resultant value to a nearest whole number, the second set value is calculated by Expression (1) shown below:
(second set value)=(number of outputs of current stage of data driver)−(delay clock number) (1).

2. The drive circuit according to claim 1, wherein
the counter unit comprises:
a first comparator that compares a counter value of the internal counter with the first set value; and
a second comparator that compares a counter value of the internal counter with the second set value,
when a counter value of the internal counter is equal to the first set value, the first comparator supplies an internal cascade signal used to reset the internal counter to the internal counter, and
when a counter value of the internal counter is equal to the second set value, the second comparator supplies the cascade signal to the subsequent stage of the data driver.

3. The drive circuit according to claim 2, wherein
the counter unit further comprises a first storage circuit that memorizes that a cascade signal is input from the previous stage of the data driver, and
when a signal indicating that a cascade signal is input from the previous stage of the data driver is input from the first storage circuit, the first comparator compares a counter value of the internal counter with the first set value.

4. The drive circuit according to claim 2, wherein
the counter unit further comprises a second storage circuit that memorizes that the first comparator outputs the internal cascade signal, and
when a signal indicating that the first comparator outputs the internal cascade signal is input from the second storage circuit, the second comparator compares a counter value of the internal counter with the second set value.

5. The drive circuit according to claim 3, wherein
the counter unit further comprises a second storage circuit that memorizes that the first comparator outputs the internal cascade signal, and
when a signal indicating that the first comparator outputs the internal cascade signal is input from the second storage circuit to, the second comparator compares a counter value of the internal counter with the second set value.

6. The drive circuit according to claim 1, wherein
each of the data drivers comprises a plurality of shift registers and a plurality of latch circuits corresponding to the plurality of shift registers,
the first comparator supplies the internal cascade signal to a first stage of the shift resister,
the plurality of shift registers transmit the internal cascade signal from one shift register to another, and
each of the latch circuits latches the display data in response to an input of the internal cascade signal from a corresponding one of the plurality shift registers.

7. The drive circuit according to claim 2, wherein
each of the data drivers comprises a plurality of shift registers and a plurality of latch circuits corresponding to the plurality of shift registers,
the first comparator supplies the internal cascade signal to a first stage of the shift resister,
the plurality of shift registers transmit the internal cascade signal from one shift register to another, and
each of the latch circuits latches the display data in response to an input of the internal cascade signal from a corresponding one of the plurality shift registers.

8. The drive circuit according to claim 3, wherein
each of the data drivers comprises a plurality of shift registers and a plurality of latch circuits corresponding to the plurality of shift registers,
the first comparator supplies the internal cascade signal to a first stage of the shift resister,
the plurality of shift registers transmit the internal cascade signal from one shift register to another, and
each of the latch circuits latches the display data in response to an input of the internal cascade signal from a corresponding one of the plurality shift registers.

9. The drive circuit according to claim 1, wherein
the counter unit comprises a driver output number recognition circuit that recognizes a number of outputs of the data driver preceding the current stage of the data driver and a number of outputs of the own data driver, and
the driver output number recognition circuit recognizes a number of output of the data driver preceding the current stage of the data driver in order starting from a first stage of the data driver, and every time the driver output number recognition circuit recognizes a number of outputs of the each data driver, the driver output number recognition circuit supplies a carry signal used to reset the internal counter to the internal counter.

10. The drive circuit according to claim 2, wherein
the counter unit comprises a driver output number recognition circuit that recognizes a number of outputs of the data driver preceding the current stage of the data driver and a number of outputs of the own data driver, and
the driver output number recognition circuit recognizes a number of output of the data driver preceding the current stage of the data driver in order starting from a first data driver, and every time the driver output number recognition circuit recognizes a number of outputs of the data driver, the driver output number recognition circuit supplies a carry signal used to reset the internal counter to the internal counter.

11. The drive circuit according to claim 3, wherein
the counter unit comprises a driver output number recognition circuit that recognizes a number of outputs of the data driver preceding the current stage of the data driver and a number of outputs of the own data driver, and
the driver output number recognition circuit recognizes a number of output of the data driver preceding the current stage of the data driver in order starting from a first data driver, and every time the driver output number recognition circuit recognizes a number of outputs of the data driver, the driver output number recognition circuit supplies a carry signal used to reset the internal counter to the internal counter.

12. The drive circuit according to claim 9, wherein the current stage of the data driver adds a pulse signal indicating a number of outputs of the current stage of the data driver to the cascade signal and sends the resultant cascade signal to the subsequent stage of the data driver.

13. The drive circuit according to claim 10, wherein the current stage of the data driver adds a pulse signal indicating a number of outputs of the current stage of the data driver to the cascade signal and sends the resultant cascade signal to the subsequent stage of the data driver.

14. The drive circuit according to claim 11, wherein the current stage of the data driver adds a pulse signal indicating a number of outputs of the current stage of the data driver to the cascade signal and sends the resultant cascade signal to the subsequent stage of the data driver.

15. A method of driving a drive circuit of a display device comprising a plurality of data drivers connected in series, the method comprising:
reading display data successively to be output to the display device by the plurality of data drivers;
inputting a common timing signal to each of the data driver at a timing when a first stage of the data driver reads a first signal of the display data, and thereby resetting each of an internal counter that count based on an internal clock, each data driver including the internal counter;
inputting a cascade signal from a previous stage of the data driver to a current stage of the data driver, when a counter value of the internal counter becomes equal to a first set value, resetting the internal counter and starting readout of the display date in the current stage of the data driver, a cascade signal specifying a timing when readout of the display data is performed, and the first set value being a number of outputs of the previous stage of the data driver; and
inputting the cascade signal to a subsequent stage of the data driver, when the counter value becomes equal to a second set value, wherein
when a delay clock number of the cascade signal is defined as a value obtained by dividing a delay time of the cascade signal by a system clock and rounding off the resultant value to a nearest whole number, the second set value is calculated by Expression (1) shown below:
(second set value)=(number of outputs of own data driver)−(delay clock number) (1).
